(19) United States
(12) Patent Application Publication
(10) Pub. No.: US 2026/0087797 A1
(43) Pub. Date: Mar. 26, 2026

(54) DEVICE AND COMPUTER IMPLEMENTED METHOD FOR PROCESSING A DIGITAL IMAGE FOR ANOMALY OR NORMALITY DETECTION

(71) Applicant: Robert Bosch GmbH, Stuttgart (DE)

(72) Inventors: Daria Stepanova, Leonberg (DE); Kilian Rambach, Stuttgart (DE); Nian Hua, Magstadt (DE); Nicole Ying Finnie, Renningen (DE); Youmna Salah Mahmoud Ismaeil, Stuttgart (DE)

(21) Appl. No.: 19/112,754

(22) PCT Filed: Jan. 11, 2024
(86) PCT No.: PCT/EP2024/050545

§ 371 Date: Mar. 18, 2025

(30) Foreign Application Priority Data
Jan. 23, 2023 (DE) 10 2023 200 470.4

(51) Int. Cl. G06V 10/98; G06V 10/22; G06V 10/74; G06V 10/764

(52) U.S. Cl. CPC G06V 10/993; G06V 10/23; G06V 10/761; G06V 10/764

(57) ABSTRACT

A device and a computer implemented method for processing a digital image for anomaly or normality detection. The method includes providing the digital image, determining, depending on the digital image, a geometric relationship between objects depicted in the digital image, providing knowledge about normal and/or abnormal geometric relationships between objects, determining, depending on the geometric relationship between the objects and the knowledge a likelihood indicating a normal or an abnormal geometric relation between objects in the digital image, and detecting an anomaly or a normality depending on the likelihood.

### FIELD

The present invention relates to a method and a device for processing a digital image for anomaly or normality detection.

### BACKGROUND INFORMATION

Biase, G. D., Blum, H., Siegwart, R., Cadena, C., “Pixel-wise anomaly detection in complex driving scenes,” in: IEEE Conference on Computer Vision and Pattern Recognition, CVPR 2021, virtual, Jun. 19-25, 2021. pp. 16918-16927; Computer Vision Foundation/IEEE (2021) describes deciding whether a given image is an anomaly on a pixel level.

Eiter, T., Kaminski, T., “Exploiting contextual knowledge for hybrid classification of visual objects,” in: JELIA. Lecture Notes in Computer Science, vol. 10021, pp. 223-239 (2016) describes classifying images based on manually specified constraints such that none of the constraints is violated.

### SUMMARY

According to an example embodiment of the present invention, a computer implemented method for processing a digital image for anomaly or normality detection includes providing the digital image, determining, depending on the digital image, a geometric relationship between objects depicted in the digital image, providing knowledge about normal and/or abnormal geometric relationships between objects, determining, depending on the geometric relationship between the objects and the knowledge a likelihood indicating a normal or an abnormal geometric relation between objects in the digital image, and detecting an anomaly or a normality depending on the likelihood. The geometric relationship of objects provides a good basis for detecting anomaly. This information is available from knowledge that is used to improve the anomaly or normality detection.

According to an example embodiment of the present invention, determining the likelihood may comprise determining for a plurality of pairs of objects depicted in the digital image, pairwise a likelihood value and determining the likelihood depending on the likelihood values. This provides a likelihood value of the image based on the pairwise values for objects depicted therein. This improves the detection further.

According to an example embodiment of the present invention, determining the likelihood depending on the likelihood values may comprise determining the likelihood depending on a weighted sum of the likelihood values, depending on a smallest of the likelihood values, depending on a largest of the likelihood values.

According to an example embodiment of the present invention, the method may comprise determining the geometric relationship between a first object and a second object in particular depending on a scene graph, wherein the knowledge comprises a knowledge graph defining allowed and/or unallowed relationships, wherein determining the likelihood value for the first object and the second object comprises determining the likelihood value to indicate normality upon finding that the geometric relationship meets the knowledge about allowed relationships from the knowledge graph or violates the knowledge about unallowed relationships from the knowledge graph, or determining the likelihood value to indicate anomaly upon finding that the geometric relationship violates the knowledge about allowed relationships from the knowledge graph or meets the knowledge about unallowed relationships from the knowledge graph. This integrates the knowledge graph to improve the detection further. The scene graph presents geometric relationships of all objects the knowledge graph defines if which of these geometric relationships are normal or is abnormal.

The method may comprise determining the geometric relationship between a first object and a second object, wherein the knowledge comprises a rule that determines that the first object and the second object are in a normal geometric relationship or an abnormal geometric relationship, wherein determining the likelihood value for the first object and the second object comprises determining the likelihood value to indicate normality upon finding that the first object and the second object are in a normal geometric relationship according to the rule, or determining the likelihood value to indicate anomaly upon finding that the first object and the second object are in an abnormal geometric relationship according to the rule. This integrates the rule to improve the detection further.

The method may comprise classifying the likelihood with a classifier indicating anomaly or normality depending on the likelihood.

The method may comprise determining a semantic similarity between objects depicted in the digital image, wherein the method comprises classifying the likelihood and the semantic similarity with a classifier indicating anomaly or normality depending on the likelihood and the semantic similarity. This aggregates semantic similarity and likelihood. The additional information provided by the semantic similarity improves the detection further.

Determining the geometric relationship may comprise determining positions of the objects, determining a scene graph depending on the positions and determining the geometric relationship depending on the scene graph. The positions reliably indicate the geometric relationship between objects.

According to an example embodiment of the present invention, a device for processing a digital image for anomaly or normality detection comprises at least one processor and at least one memory, wherein the at least one processor is configured to execute instructions that, when executed by the at least one processor cause the device to execute the method, and wherein the at least one memory is configured to store the instructions.

A computer program comprises instructions that, when executed by a computer cause the computer to execute the method.

Further advantageous embodiments of the present invention may be derived from the following description and the figures.

### BRIEF DESCRIPTION OF THE DRAWINGS

FIG. 1 schematically depicts a device for processing digital images, according to an example embodiment of the present invention.

FIG. 2 schematically depicts a normal situation.

FIG. 3 schematically depicts an abnormal situation.

FIG. 4 schematically depicts a printed circuit board comprising different objects.

FIG. 5 depicts a flow chart of a first example embodiment of a method for processing digital images, according to the present invention.

FIG. 6 depicts a flow chart of a second example embodiment of the method for processing digital images, according to the present invention.

### DETAILED DESCRIPTION OF EXAMPLE EMBODIMENTS

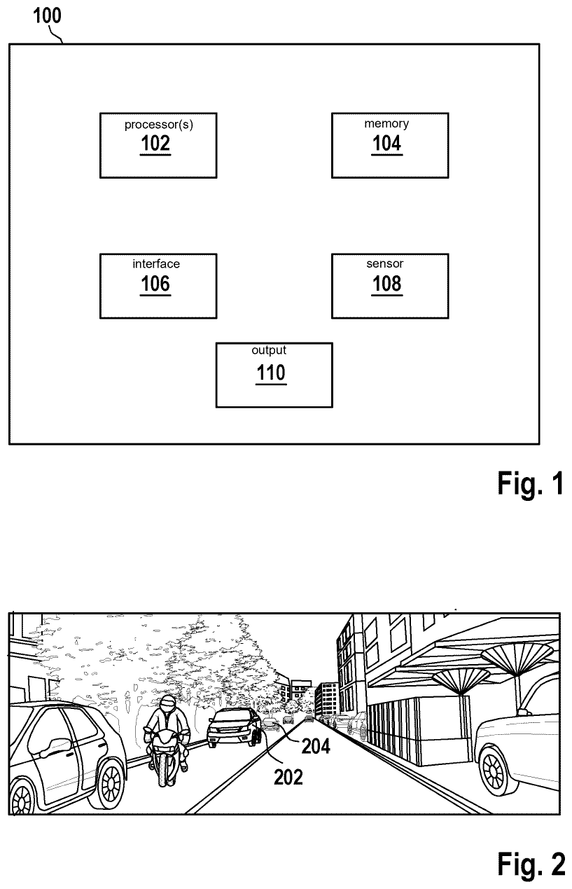

FIG. 1 schematically depicts a device 100 for processing digital images.

The device 100 comprises at least one processor 102 and at least one memory 104.

The device 100 comprises an interface 106 for a sensor 108 and/or the sensor 108. In the example depicted in FIG. 1, the device 100 comprises the sensor 108.

The sensor 108 is for example a camera, a radar sensor, a LiDAR sensor, a motion sensor, an infrared sensor or an ultrasonic sensor.

The sensor 108 is configured to capture a digital image or to reconstruct a digital image using the geometric information captured by the sensor 108. For example, LiDAR or radar points are processed to reconstruct a digital image of a driving scene. The sensor 108 is in one example configured to capture sensor data from the sensor 108 or a plurality of sensors 108 for determining the digital image e.g. of an environment of the device 100. The digital image may be determined by the device 100 depending on the sensor data.

The digital image represents visual data. The digital image may represent visual data, captured or reconstructed by the sensor 108, e.g., a camera, a radar, a LiDAR or an ultrasound sensor.

The device 100 may be configured for detecting objects in the digital image. In one example, the device 100 is configured to detect the objects from a set of digital images captured by the sensor 108.

The device 100 may be configured for detecting objects with an object detection model, e.g. a R-CNN, YOLO, CenterNet, DETR model. The object detection model applied on test data may be trained using the training data from the same distribution. The object detection model applied on test data may be trained on other training data and be directly applied on the test data (zero-shot transfer).

The device 100 may be configured for detecting classes of objects in the digital image. In one example, the device 100 is configured to detect the classes from a set of digital images captured by the sensor 108.

The output from the object detection model may include the objects identified, such as cars, pedestrians, traffic lights. The output from the object detection model may include the object locations, such as the xmin, xmax, ymin and ymax of a two-dimensional bounding box, or a location (x, y, z) of a three-dimensional central box with each box dimension x, y, z. The output from the object detection model may include the object's classification scores.

The output from the object detection model may be further used for generating a scene graph.

The scene graph is for example determined as described in “Scene Graph Generation: A Comprehensive Survey” arxiv.org/pdf/2201.00443.pdf

The present invention relates to a problem of semantic anomaly detection, to decide if a certain measured scene or scenario is normal or abnormal: Given some input data, e.g., a set of images, the device 100 is configured to decide whether they depict a realistic, i.e. a normal, geometric relationship of objects or a unrealistic, i.e. an abnormal, geometric relationship.

As an example, a geometric relationship of objects like a car driving in front of another car corresponds to a normal situation.

FIG. 2 schematically depicts a normal situation, wherein a first car 202 is in front of a second car 204.

As an example, a geometric relationship of a car overlaid at least partially by another car is considered in this disclosure as abnormal situation.

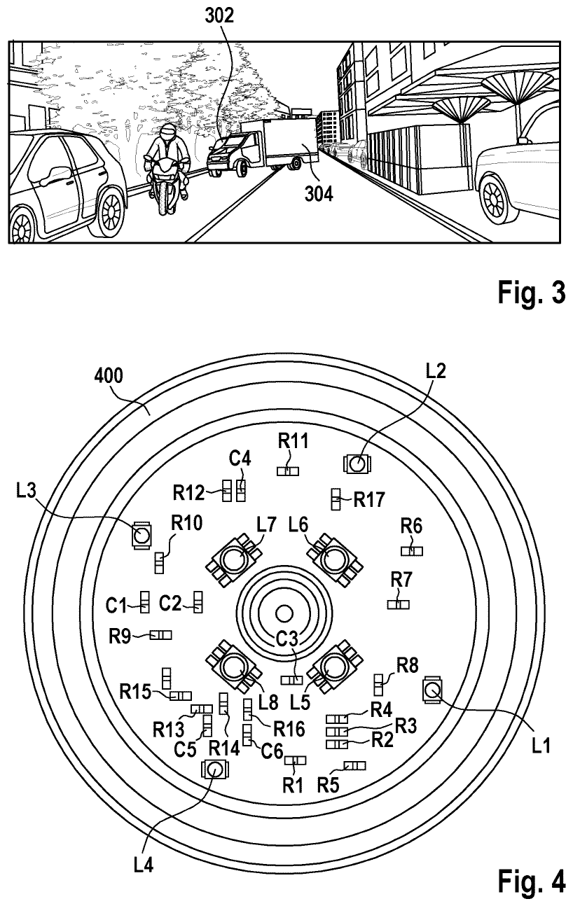

FIG. 3 schematically depicts an abnormal situation, wherein a first car 302 is overlaid partially by a second car 304.

The considered problem is important and relevant in a number of applications, e.g., autonomous driving or visual inspection of products assembled by robots.

For example, in the autonomous driving domain, the device 100 is an autonomous vehicle or a part thereof that is configured to reliably distinguish a normal geometric relationship of objects from an abnormal geometric relationship of objects.

In an adversarial attack, an attacker may put a sticker in a back of a car in an attempt to make device 100 to misclassify the sticker to be a <STOP> sign.

A constraint for mitigating this misclassification is:

<-locatedIn(X, Y), type(X, “StopSign”), type(Y, “Car”

That means the sticker, misclassified as a <STOP> sign would violate the constraint LocatedIn(StopSign, Car).

The device 100 is configured to base its decision on the normal geometric relationship of objects. The device 100 is in one example configured to detect a scene with an unusual geometric relationship of objects as a normal scene. The device 100 is for example configured to detect a scene comprising as objects car transporter loaded with a car as a normal scene. The device 100 is in one example configured to detect a scene with an unusual geometric relationship of objects as an abnormal scene. The device 100 is in one example configured to distinguish whether an unusual geometric relationship of objects represents a normal scene or an abnormal scene.

For example, in the manufacturing domain, the device 100 is an assembly or a part thereof that is configured to detect a geometric relationship of parts of a product, in particular a product that is automatically manufactured. The device 100 is configured to distinguish whether the detected geometric relationship of parts represents a normal geometric relationship of the parts or an abnormal geometric relationship of parts. The device 100 is for example configured to detect that the product comprises a plastic top and a metal bottom. The device 100 is for example configured to detect that this geometric relationship is abnormal, e.g., for a particular electronic control unit architecture. The device 100 is configured to identify issues with the product in case the abnormal geometric relationship is detected.

FIG. 4 schematically depicts a printed circuit board, PCB board, 400 comprising different objects. Exemplary objects are light emitting devices, LEDs, L1, . . . , L8, resistors R1, . . . . R17 and capacitors C1, . . . , C6 at certain locations.

The device 100 is configured to detect and classify the different objects.

The device 100 is configured to evaluate a Knowledge graph and/or expert defined rules that specify which objects are expected to be at which locations w.r.t. each other.

In the example depicted in FIG. 4, e.g. the knowledge graph and/or expert defined rules define that a resistor is on the right side of an LED. If the expected placement of the objects is not detected, this is likely to be an outlier, i.e. a defectively produced part, which the classifier can identify.

The device 100 comprises in one example a classifier that is configured to detect the anomaly or normality.

For the example depicted in FIG. 4, the device 100 may be configured to detect the outlier, i.e. the defectively produced part.

The device 100 may comprise an output 110. The output 110 is for example configured to output a result of detecting normality or anomaly. The output 110 may be configured to control an operation of the device 100, e.g. an action by the device 100.

Detecting anomalies in images can be often challenging due to very low volume of anomalous images to meaningfully train a detector. A model that is trained with enough data, e.g. Open world data, like ChatGPT, cannot fit on an embedded device or a device in a car. The logical-rule-based auxiliary approach could compensate for this. In addition, without auxiliary exogenous information, the quality of the detector depends greatly on the training data.

Methods for anomaly or normality detection may use an output from the object detection model comprising the objects identified and the object's location.

The detection is improved by injecting exogenous information through rules or a knowledge graph.

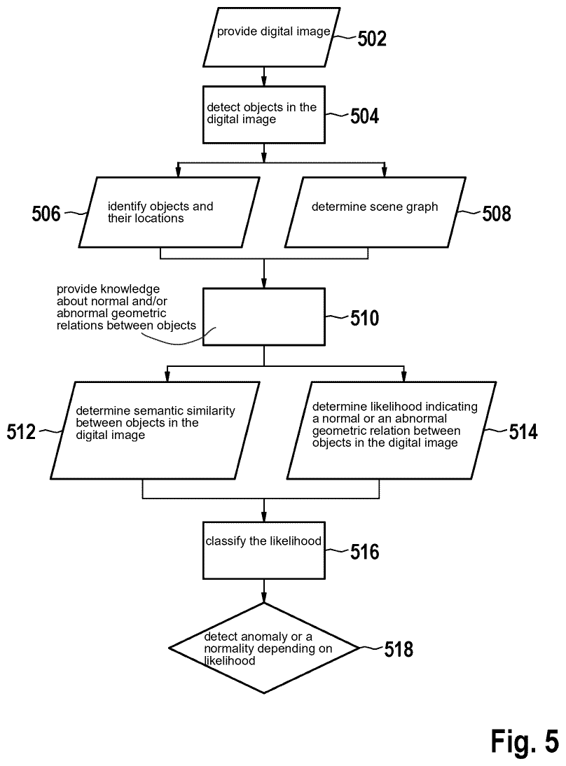

FIG. 5 depicts a flow chart of a corresponding first embodiment of a method for processing digital images.

The method comprises a step 502.

In the step 502, a digital image is provided.

The image is for example provided via the interface 106. The image is for example captured by the sensor 108.

Afterwards, a step 504 is executed.

In the step 504, objects depicted in the digital image are detected.

In the example, a plurality of objects is detected.

Afterwards, the objects in the plurality of objects are identified in a step 506 and their locations and a scene graph are determined in a step 508.

Step 508 comprises determining a geometric relationship between objects depicted in the digital image depending on the scene graph.

Determining the geometric relationship in one example comprises determining positions of the objects and determining the geometric relationship depending on their positions.

By way of example, the geometric relationship between a first object i and a second object j is determined.

Afterwards, a step 510 is executed.

The step 510 comprises providing the knowledge about normal and/or abnormal geometric relationships between objects.

In the first embodiment, providing the knowledge comprises providing the knowledge graph or a set of rules.

By way of example, the rule is configured to determine whether the first object i and the second object j are in an allowed geometric relationship or in an unallowed geometric relationship. The rules can be defined by experts or learned via ILP (inductive logical programming) by training a model with positive and negative examples from the scene.

The knowledge graph and the set of rules define allowed or unallowed geometric relationships for objects.

The knowledge graph comprises nodes representing objects and edges representing relations between the objects.

According to one example, the knowledge graph comprises an edge that connects a first node representing the first object and a second node representing the second object. This edge corresponds to the geometric relationship between the first object and the second object.

According to one example, the knowledge graph lacks an edge that connects the first node and the second node. This lack of the edge may correspond to a lack of information regarding the geometric relationship between the first object and the second object.

This lack of the edge may correspond to the geometric relationship between the first object and the second object. For example, in a knowledge graph capturing with edges normal geometric relationships, the lack of an edge may indicate an abnormal geometric relationship. For example, in a knowledge graph capturing with edges abnormal geometric relationships, the lack of an edge may indicate a normal geometric relationship.

By way of example, the knowledge graph comprises a first node representing the first object i and a second node representing the second object j.

Optionally, the method comprises a step 512.

The step 512 comprises determining a semantic similarity between objects depicted in the digital image.

Determining the semantic similarity may comprise determining a plurality of pairs of objects depicted in the digital image.

Determining the semantic similarity may comprise determining a semantic similarity value for each of the pairs in the plurality of pairs.

Determining the semantic similarity may comprise determining the semantic similarity depending on these semantic similarity values.

For example, the semantic similarity is determined depending on a weighted sum of the semantic similarity values.

For example, the semantic similarity is determined depending on a smallest of the semantic similarity values.

For example, the semantic similarity is determined depending on a largest of the semantic similarity values.

Afterwards, a step 514 is executed.

The step 514 comprises determining, depending on the geometric relationship between the objects and the knowledge a likelihood indicating a normal or an abnormal geometric relation between objects in the digital image.

Determining the likelihood may comprise determining a plurality of pairs of objects depicted in the digital image.

Determining the likelihood may comprise determining a likelihood value for each of the pairs in the plurality of pairs.

Determining the likelihood may comprise determining the likelihood depending on these likelihood values.

For example, the likelihood is determined depending on a weighted sum of the likelihood values.

For example, the likelihood is determined depending on a smallest of the likelihood values.

For example, the likelihood is determined depending on a largest of the likelihood values.

The likelihood value for the first object and the second object may be determined to indicate normality upon finding a rule in the set of rules that determines that the first object and the second object are in a normal geometric relationship.

The likelihood value for the first object and the second object may be determined to indicate anomaly upon finding a rule in the set of rules that determines that the first object and the second object are in an abnormal geometric relationship.

The likelihood value for the first object and the second object may be determined to indicate normality upon finding that the knowledge graph indicates that the first object and the second object are in a normal geometric relationship.

The likelihood value for the first object and the second object may be determined to indicate anomaly upon finding the knowledge graph indicates that the first object and the second object are in an abnormal geometric relationship.

The likelihood value for the first object and the second object may be determined to indicate normality upon finding that an edge in the knowledge graph exists, that connects the first node and the second node and that represents a normal geometric relationship and that corresponds to the determined geometric relationship between the first object and the second object.

The likelihood value for the first object and the second object may be determined to indicate normality upon finding that the knowledge graph that comprises edges for abnormal geometric relationships lacks an edge that connects the first node and the second node and that represents the determined geometric relationship between the first object and the second object.

The likelihood value for the first object and the second object may be determined to indicate anomaly upon finding that an edge in the knowledge graph exists, that connects the first node and the second node and that represents an abnormal geometric relationship and that corresponds to the determined geometric relationship between the first object and the second object.

The likelihood value for the first object and the second object may be determined to indicate anomaly upon finding that the knowledge graph that comprises edges for normal geometric relationships lacks an edge that connects the first node and the second node and that represents the determined geometric relationship between the first object and the second object.

The first embodiment comprises querying the pairs (i, j) of identified objects from the knowledge graph, determining their likelihood values and determining the likelihood from these values.

Afterwards, a step 516 is executed.

The step 516 comprises classifying the likelihood with a classifier indicating anomaly or normality depending on the likelihood.

Optionally, the step 516 comprises classifying the likelihood and the semantic similarity together with a classifier indicating anomaly or normality depending on the likelihood and the semantic similarity.

Afterwards, a step 518 is executed.

The step 518 comprises detecting an anomaly or a normality depending on the likelihood.

The detected result, i.e. anomaly or normality, may be output in particular via output 110.

Optionally, the operation of the device 100, e.g. an action by the device 100, is controlled depending on the detected result.

The detection is improved by injecting exogenous information through expert defined rules.

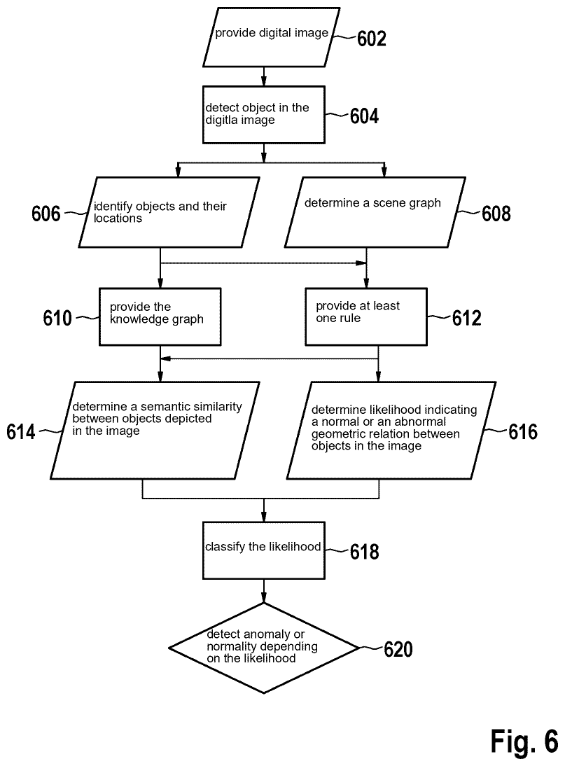

FIG. 6 depicts a flow chart of a corresponding second embodiment of the method for processing digital images.

The method comprises a step 602.

In the step 602, a digital image is provided.

The image is for example provided via the interface 106. The image is for example captured by the sensor 108.

Afterwards, a step 604 is executed.

In the step 604, objects depicted in the digital image are detected.

In the example, a plurality of objects is detected.

Afterwards, the objects in the plurality of objects are identified in a step 606 and their locations and a scene graph are determined in a step 608.

Step 608 comprises determining the scene graph depending on the locations.

Step 608 comprises determining a geometric relationship between objects depicted in the digital image depending on the scene graph.

Determining the geometric relationship in one example comprises determining positions of the objects and determining the geometric relationship depending on their positions.

By way of example, the geometric relationship between a first object i and a second object j is determined.

Afterwards, a step 610 and a step 612 are executed to provide the knowledge about normal and/or abnormal geometric relationships between objects.

The step 610 comprises providing the knowledge graph.

The step 610 comprises providing at least one rule.

The rule determines for the first object and the second object either a normal geometric relationship or an abnormal geometric relationship.

The likelihood value for the first object and the second object is determined to indicate normality upon finding that the first object and the second object are in a normal geometric relationship according to the rule.

The likelihood value for the first object and the second object is determined to indicate anomaly upon finding that the first object and the second object are in an abnormal geometric relationship according to the rule.

The meeting of a rule for the first object and the second object in a set of rules indicating normal geometric relationships may result in determining the likelihood value to indicate normality.

The violation of a rule for the object and the second object in a set of rules indicating abnormal geometric relationships may result in determining the likelihood value to indicate anomaly.

Optionally, the method comprises a step 614.

The step 614 comprises determining a semantic similarity between objects depicted in the digital image.

Determining the semantic similarity may comprise determining a plurality of pairs of objects depicted in the digital image.

Determining the semantic similarity may comprise determining a semantic similarity value for each of the pairs in the plurality of pairs.

Determining the semantic similarity may comprise determining the semantic similarity depending on these semantic similarity values.

For example, the semantic similarity is determined depending on a weighted sum of the semantic similarity values.

For example, the semantic similarity is determined depending on a smallest of the semantic similarity values.

For example, the semantic similarity is determined depending on a largest of the semantic similarity values.

Afterwards, a step 616 is executed.

The step 616 comprises determining, depending on the geometric relationship between the objects and the knowledge a likelihood indicating a normal or an abnormal geometric relation between objects in the digital image.

Determining the likelihood may comprise determining a plurality of pairs of objects depicted in the digital image.

Determining the likelihood may comprise determining a likelihood value for each of the pairs in the plurality of pairs.

Determining the likelihood may comprise determining the likelihood depending on these likelihood values.

For example, the likelihood is determined depending on a weighted sum of the likelihood values.

For example, the likelihood is determined depending on a smallest of the likelihood values.

For example, the likelihood is determined depending on a largest of the likelihood values.

The likelihood value for the first object and the second object may be determined to indicate normality upon finding that an edge in the knowledge graph exists, that connects the first node and the second node and that represents a normal geometric relationship and that corresponds to the determined geometric relationship between the first object and the second object.

The likelihood value for the first object and the second object may be determined to indicate normality upon finding that the knowledge graph that comprises edges for abnormal geometric relationships lacks an edge that connects the first node and the second node and that represents the determined geometric relationship between the first object and the second object.

The likelihood value for the first object and the second object may be determined to indicate anomaly upon finding that an edge in the knowledge graph exists, that connects the first node and the second node and that represents an abnormal geometric relationship and that corresponds to the determined geometric relationship between the first object and the second object.

The likelihood value for the first object and the second object may be determined to indicate anomaly upon finding that the knowledge graph that comprises edges for normal geometric relationships lacks an edge that connects the first node and the second node and that represents the determined geometric relationship between the first object and the second object.

The second embodiment comprises evaluating rules for the pairs (i, j) of identified objects from the set of rules, determining their likelihood values and determining the likelihood from these values.

Afterwards, a step 618 is executed.

The step 618 comprises classifying the likelihood with a classifier indicating anomaly or normality depending on the likelihood.

Optionally, the step 618 comprises classifying the likelihood and the semantic similarity together with a classifier indicating anomaly or normality depending on the likelihood and the semantic similarity.

Afterwards, a step 620 is executed.

The step 620 comprises detecting an anomaly or a normality depending on the likelihood.

The second embodiment comprises querying the pairs (i, j) of identified objects from the knowledge graph and in addition, checking the object pairs (i, j) and their geometric relationships through the rules. The rules are for example learned or expert-defined. The rules can be defined by experts or learned via ILP (inductive logical programming) by training a model with positive and negative examples from the scene.

The detected result, i.e. anomaly or normality, may be output in particular via output 110.

Optionally, the operation of the device 100, e.g. an action by the device 100, is controlled depending on the detected result.

The positions are for example determined with a two-dimensional object detection model as two-dimensional positions x, y or with a three-dimensional object detection model as three-dimensional positions x, y, z.

For example, the positions of the first object i and the second object j are determined in an image k.

The likelihood

$${R}_{i , r , j}^{k}$$

of the first object i and the second object j being in a geometric relationship r is determined, with the knowledge graph or a rule comprising the first object i and the second object j.

In one case, the likelihood

$${R}_{i , r , j}^{k}$$

is determined by checking whether the triple i,r,j> exists in the knowledge graph or in the set of rules.

For example, given an object pair of first object i=pedestrian and second object j=street as well as the geometric relationship r=above detected to hold between the first object i and the second object j based on the image k, the result is likelihood

$${R}_{i , r , j}^{k} = 1 ,$$

if pedestrian, above, street> is in the knowledge graph, and

$${R}_{i , r , j}^{k} = 0$$

otherwise.

For a given set of rules, the result in this case may be likelihood

$${R}_{i , r , j}^{k} = 1$$

if a rule pedestrian, street→above is in the set of rules, and

$${R}_{i , r , j}^{k} = 0$$

otherwise.

The knowledge graph or the rule may comprise two-dimensional or three-dimensional geometric relationships.

The three-dimensional object detection model may be used to determine a three-dimensional geometric relationship between two objects and to query the three-dimensional geometric relationship from the knowledge graph.

An example for a result of this query for a pedestrian and a traffic light may be a likelihood indicating a normal relationship for a pedestrian that is depicted behind a traffic light in the digital image.

The semantic similarity is for example determined by relying on a cosine similarity of vectors corresponding to the nodes representing the objects in the knowledge graph.

The semantic similarity and/or the likelihood are determined based on image level features.

The classifier may be trained for anomaly detection using an supervised anomaly classification approach, where anomalous and normal data are labeled. In one example, the classifier is trained as anomaly detector to determine the likelihood and compare it against an anomaly threshold. The classifier may be trained to detect normality, in case the likelihood exceeds the threshold or detect abnormality otherwise. The classifier may be trained to detect anomaly, in case the likelihood exceeds the threshold or detect normality otherwise.

The classifier may be trained for normality detection using an supervised anomaly classification approach, where anomalous and normal data are labeled. In one example, the classifier is trained as normality detector to determine the likelihood and compare it against an anomaly threshold. The classifier may be trained to detect normality, in case the likelihood exceeds the threshold or detect abnormality otherwise. The classifier may be trained to detect anomaly, in case the likelihood exceeds the threshold or detect normality otherwise.

The classifier may comprise a decision tree or forest, a neural network or a logistic regression model.

For example, in the manufacturing domain, the classifier may be trained and the method may be used to classify the geometric relationship of parts of the product as normal or abnormal. The method may be used to distinguish depending on the result of the classification, whether the detected geometric relationship of parts represents a normal geometric relationship of the parts or an abnormal geometric relationship of parts. The method for example identifies issues with the product in case the abnormal geometric relationship is detected. In particular, when the product is automatically manufactured, the method may comprise automatically labelling or disposing off the product in case issues with the product are identified.

Issues are for example identified, in case it is identified by the geometric relationship between the objects, that these are located erroneously on the printed circuit board, PCB board.

1-10. (canceled)

11. A computer implemented method for processing a digital image for anomaly or normality detection, the method comprising the following steps:
providing the digital image;
determining, depending on the digital image, a geometric relationship between objects depicted in the digital image;
providing knowledge about normal and/or abnormal geometric relationships between objects;
determining, depending on the geometric relationship between the objects and the knowledge, a likelihood indicating a normal or an abnormal geometric relation between objects in the digital image; and
detecting an anomaly or a normality depending on the likelihood.

12. The method according to claim 11, wherein the determining of the likelihood includes determining for a plurality of pairs of objects depicted in the digital image, pairwise, a likelihood value and determining the likelihood depending on the likelihood values.

13. The method according to claim 12, wherein the determining of the likelihood depending on the likelihood values includes determining the likelihood depending on a weighted sum of the likelihood values, and/or depending on a smallest of the likelihood values, and/or depending on a largest of the likelihood values.

14. The method according to claim 12, wherein:
the determining of the geometric relationship includes determining a geometric relationship between a first object and a second object depending on a scene graph, wherein the knowledge includes a knowledge graph defining allowed and/or unallowed relationships, wherein the determining of the likelihood value includes determining of the likelihood value for the first object and the second object including: (i) determining the likelihood value for the first object and the second object to indicate normality upon finding that the geometric relationship meets the knowledge about allowed relationships from the knowledge graph or violates the knowledge about unallowed relationships from the knowledge graph, or (ii) determining the likelihood value for the first object and the second object to indicate anomaly upon finding that the geometric relationship violates the knowledge about allowed relationships from the knowledge graph or meets the knowledge about unallowed relationships from the knowledge graph.

15. The method according to claim 11, wherein:
the determining of the geometric relationship including determining a geometric relationship between a first object and a second object, wherein the knowledge includes a rule that determines that the first object and the second object are in a normal geometric relationship or an abnormal geometric relationship, wherein the determining of the likelihood value includes determining the likelihood value for the first object and the second object including: (i) determining the likelihood value to indicate normality upon finding that the first object and the second object are in a normal geometric relationship according to the rule, or (ii) determining the likelihood value to indicate anomaly upon finding that the first object and the second object are in an abnormal geometric relationship according to the rule.

16. The method according to claim 11, further comprising:
classifying the likelihood with a classifier indicating anomaly or normality depending on the likelihood.

17. The method according to claim 11, further comprising:
determining a semantic similarity between objects depicted in the digital image;
classifying the likelihood and the semantic similarity with a classifier indicating anomaly or normality depending on the likelihood and the semantic similarity.

18. The method according to claim 11, wherein the determining of the geometric relationship includes determining positions of the objects, determining a scene graph depending on the positions, and determining the geometric relationship depending on the scene graph.

19. A device for processing a digital image for anomaly or normality detection, comprising:
at least one processor; and
at least one memory, wherein the at least one processor is configured to execute instructions that, when executed by the at least one processor cause the device to perform a method for processing a digital image for anomaly or normality detection, the method including the following steps:
providing the digital image,
determining, depending on the digital image, a geometric relationship between objects depicted in the digital image,
providing knowledge about normal and/or abnormal geometric relationships between objects,
determining, depending on the geometric relationship between the objects and the knowledge, a likelihood indicating a normal or an abnormal geometric relation between objects in the digital image, and
detecting an anomaly or a normality depending on the likelihood; and
wherein the at least one memory is configured to store the instructions

20. A non-transitory computer-readable medium on which is stored a computer program for processing a digital image for anomaly or normality detection, the computer program, when executed by at least one processor, causing the at least one processor to perform the following steps:
providing the digital image;
determining, depending on the digital image, a geometric relationship between objects depicted in the digital image;
providing knowledge about normal and/or abnormal geometric relationships between objects;
determining, depending on the geometric relationship between the objects and the knowledge, a likelihood indicating a normal or an abnormal geometric relation between objects in the digital image; and
detecting an anomaly or a normality depending on the likelihood.
